(19) United States
(12) Patent Application Publication
(10) Pub. No.: US 2002/0069537 A1
(43) Pub. Date: Jun. 13, 2002

(54) Cutting pliers

(76) Inventor: Peter Wenzler, Frittlingen (DE)

Correspondence Address: McGLEW AND TUTTLE, P.C., SCARBOROUGH STATION, SCARBOROUGH, NY, 10510-0827, US

(21) Appl. No.: 09/973,599

(22) Filed: Oct. 9, 2001

(30) Foreign Application Priority Data
Oct. 27, 2000 (DE) 200 18 390.7

(51) Int. Cl. B26B 17/02

(52) U.S. Cl. 30/189; 30/192; 30/181

(57) ABSTRACT

Cutting pliers for surgical purposes are used to cut through wires (40) or the like. The cutting pliers have a first two-armed hand lever (1), whose shorter, front lever arm (3) is provided with a cutting edge on its front end section. A short lever arm (11) of a second hand lever (10) is connected in terms of transmission to a two-armed cutting lever (20) having the second cutting edge via a lever transmission. To reduce the number of joints needed and to obtain higher progressions of the cutting forces on the cutting lever during the cutting operation, the short lever arm (11) of the second hand lever (10) is provided at a radially spaced location from the joint of pliers (Z) with a curved path (K₁, K₂), via which this short lever arm (11) acts on the cutting lever (20). This lever arm (25) is provided for this purpose with a transmission element (31, 31′) sliding on the curved path (Kₗ, K₂). The curved path (K, K₁, K₂) extends such that the radial distance (a₀, a₁, a₂) between the lines of force (KL₀, KL₁, KL₂) of the cutting force component acting on the curved path (K, K₁, K₂) at the power transmission point during the closing movement of the second hand lever (10) and the axis (S) of the joint of pliers (Z) changes from a maximum (a₀) at the beginning of the closing movement to a minimum (a₂) at the end of the closing movement.

### FIELD OF THE INVENTION

The present invention pertains to cutting pliers, especially for surgical purposes, for cutting through wires, nails, screws or the like, with a first, two-armed hand lever, whose longer, rear lever arm is designed as a handle and whose shorter, front lever arm is provided at its front end section with a cutting edge, and with a likewise two-armed second hand lever, which is pivotably articulated on the first hand lever by means of a joint of pliers and which has, besides a second handle designed and arranged mirror symmetrically to the handle of the first hand lever, a front, short lever arm, which is connected in terms of transmission to a two-armed cutting lever, which is articulated to the short lever arm of the first hand lever and which has a second cutting edge or the like, via a lever transmission such that the cutting force exerted on the cutting edges via the handles increases super proportionally with increasing closing movement.

### BACKGROUND OF THE INVENTION

Pliers of this type for surgical purposes for cutting through wires, screws or the like have already been known from EP 0 321 884 B1.

These pliers are provided with a cutting hand lever, which has a cutting edge at its front end and a handle at its rear end. A cutting lever, which has a second cutting edge located opposite the first cutting edge, is mounted on this cutting hand lever by means of a cutting lever joint. In addition, a hand lever is pivotably articulated to the cutting hand lever by means of a hand lever joint, and a transmission mechanism, which acts on a drive member of the hand lever, is arranged between the hand lever and the cutting lever. The drive member of the transmission mechanism acts on the cutting lever on the side of a cutting lever joint facing away from the cutting edge, wherein the said cutting lever joint supports the cutting lever on the cutting hand lever, and equal relative pivoting movements of the hand lever in relation to the cutting hand lever bring about a markedly decreasing pivoting of the cutting lever in relation to the cutting hand lever, so that the power ratio automatically increases with decreasing distance between the respective handles provided on the hand lever and the cutting hand lever. This means that the leverage changes with increasing closing movement such that a steadily decreasing angular movement of the moving cutting edge to the other cutting edge takes place at a given angular movement of one hand lever toward the other. An increasing cutting force is obtained on the moving cutting edge due to this change in transmission, which inevitably arises during the closing movement.

This change in transmission can be attributed to the change of the lever arm which brings about the movement of the cutting edge.

The change of the effective lever arm is achieved by a kind of toggle joint in one embodiment of the prior-art pliers. A short lever arm of the first lever arm mounted on the second lever arm in a pivotably movable manner is connected by a strap in an articulated manner to a longer lever arm of a two-armed hand lever, which is likewise mounted pivotably on the second lever arm of the hand lever. Thus, a total of four joints are provided in these prior-art pliers. At the lever ratios shown in the drawing, a change which corresponds to a factor of about 1.7 occurs in the cutting force during the entire closing movement. This means that the initial cutting force increases by a factor of 1.7 until the end of the closing movement.

In another embodiment of these prior-art pliers, a toggle lever is mounted pivotably on the first hand lever, whose second, shorter arm is provided with the first cutting edge, and on which a two-armed cutting lever as well as the second hand lever are pivotably mounted. Via a joint, this toggle lever is in connection with a push rod, which is in turn articulated to the other end of the movable hand lever. The toggle lever is in connection with the longer lever arm of the cutting lever via a connection member in an articulated manner. Changes occur in this arrangement concerning two effective lever arms during the closing movement, namely, in the effective lever arm at the toggle lever and in the effective lever arm at the cutting lever.

A total of six joints are needed in this embodiment and an increase in the cutting force by a factor of about 28 is reached at the lever ratios shown in the drawings.

While the embodiment with the four joints comprises essentially four movable parts connected to one another, the other embodiment of these prior-art pliers with the two toggle levers has six parts connected to one another in an articulated manner.

### SUMMARY AND OBJECTS OF THE INVENTION

The basic object of the present invention is to provide cutting pliers of the type mentioned in the introduction, which consist of the smallest possible number of parts and require, in particular, fewer joints than the prior-art cutting pliers and with which greater and different progressions of the cutting forces can also be obtained within one cutting operation.

This object is accomplished according to the present invention by the short lever arm of the second hand lever having a curved path at a radially spaced location from the joint of pliers, and the said short lever arm acts via the said curved path during a cutting operation on the lever arm of the cutting lever which latter lever arm faces it, and the cutting lever is provided for this purpose with a transmission element rolling or sliding on the curved path with low friction, and by the curved path extending such that the radial distance between the line of force of the effective closing force component at the contact point between the roller and the curved path during a closing movement of the second hand lever and the axis of the joint of pliers changes from a maximum at the beginning of the closing movement to a minimum at the end of the closing movement.

Aside from the fact that the cutting pliers according to the present invention comprise only a total of three pliers parts connected to one another in an articulated manner and only two joints as well as one curved path, cutting pliers in which the cutting forces that bring about the cutting off of a wire, a screw or the like can be individually adapted to the users' wishes can be manufactured based on the underlying design and function principle of the present invention. The only thing that is necessary for this is to impart a corresponding shape to the curved path, and it is possible for the curved path to have different slopes, which have different effects on the progressiveness of the increase in the cutting force.

It is, above all, possible to place the greatest progression of the increase in the force into the range of the closing angle in which the cutting resistance is also highest by a corresponding design of the curved path.

An embodiment according to the invention makes possible a simple standard design, in which the progression ranges within the closing angle or over the entire course of the curved path according to the sine function that depends on the closing angle, and it is possible to select the most favorable range of this sine function, e.g., that with the greatest pitch.

The cutting pliers according to the present invention can be manufactured in a very simple and inexpensive manner according to particular embodiments. In addition, such pliers can be handled in a very simple manner.

Instead of the roller provided according to another aspect of the invention as a transmission element, it is also possible to provide an embodiment in which provides for a sliding block as a transmission element.

Further embodiments according to the invention pertain to an exemplary embodiment in which the curved path has no continuous pitch and no continuous course and consequently no continuous progressiveness over its entire length, either. This curved path rather comprises two sections with different pitches or curvatures, which are selected to be such that the greatest increase in force on the cutting edges is reached at the end of the first section that is located approximately in the middle of the curved path, while the progression becomes weaker in the course of the further closing angle or the second section.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side view of cutting pliers in the opened state;

FIG. 2 is a partially cut-away view II from FIG. 1;

FIG. 3 is a section III-III from FIG. 1;

FIG. 4 is the narrow-side view of the articulated two-armed hand lever;

FIG. 5 is the hand lever according to FIG. 4 in a side view,

FIG. 5a is an enlarged view of the head part of the hand lever according to FIG. 5;

FIG. 6 is a narrow-side view VI of the cutting lever from FIG. 1;

FIG. 7 is a narrow-side view VII of the first handle part;

FIG. 8 is a side view of the cutting pliers in the closed state;

FIG. 8a is a schematic view of the lever ratios of the cutting pliers at the beginning of a cutting movement;

FIG. 8b is a schematic view of the lever ratios of the cutting pliers at the end of the cutting movement;

FIG. 9 is a schematic simplified but enlarged view of the connecting link guide with the line of force acting on the transmission element designed as a roller at the beginning of the curved path;

FIG. 10 is a schematic simplified but enlarged view of the connecting link guide with the line of force acting on the transmission element designed as a roller in the middle of the curved path;

FIG. 11 is a schematic simplified but enlarged view of the connecting link guide with the line of force acting on the transmission element designed as a roller at the end of the curved path;

FIG. 12 is a schematic simplified but enlarged view of the connecting link guide with the transmission element designed as a roller;

FIG. 13 is an enlarged view of another form of the connecting link guide with a sliding block as the transmission element;

FIG. 14 is the sliding block from FIG. 13;

FIG. 15 is a schematic view of the angle and power arms which act on the joint of pliers and on a curved path with uniform curvature;

FIG. 16 is a schematic view of the curved path from FIG. 15 in relation to the joint of pliers;

FIG. 17 is a schematic view of the power arms acting on the joint of pliers in the case of a curved path with different curvatures; and

FIG. 18 is the curved path from FIG. 17 in relation to the joint of pliers.

### DESCRIPTION OF THE PREFERRED EMBODIMENTS

Referring to the drawings in particular, the cutting pliers shown in the drawings, which were developed for surgical purposes and are used to cut through wires, nails, screws or other similar surgical auxiliary means, have a first two-armed hand lever 1, whose longer, rear lever arm 2 is designed as a handle and whose shorter, front lever arm 3 is provided on its front end section with a replaceable cutting tip 4.

A second, likewise two-armed hand lever 10 is pivotably articulated to the first hand lever 1 by means of a joint of pliers Z. This second hand lever 10 likewise has a longer lever arm 12, which is designed as a handle, and this handle of the second hand lever 10 is designed and arranged approximately mirror symmetrically to the handle of the first hand lever 1.

A front, shorter lever arm 11, which has the shape of a thinner plate and which is pivotably guided in a correspondingly designed slot-like opening 13 of the first lever arm 1, has a joint hole 14. The short lever arm 11 of the second hand lever 10 is mounted pivotably on a joint bolt 15 of this first hand lever 1 with this joint hole 14. The joint bolt 15 and the joint hole 14 form the joint of pliers Z.

Via this short lever arm 11, the second hand lever 10 is in connection in terms of transmission with a two-armed cutting lever 20, which is articulated to the short lever arm of the first hand lever 1 by means of a joint G. The cutting lever 20 is also provided with a slot-like opening 21 for the pivotable mounting of the plate-like short lever arm 11 of the second hand lever 12. In addition, the bearing eye 22 of the joint G is also provided with a slot-like opening 23, by which a likewise plate-like joint eye 24 of the front lever 3 of the first hand lever 1 is received. The joint G has the same design as the joint of pliers Z.

The connection in terms of transmission between the short lever arm 11 of the second hand lever 10 and the slotted lever arm 25 of the cutting lever 20 comprises a connecting link guide 30, which is prepared in the form of a curved elongated hole in the short lever arm 11, as well as a roller 31 acting as a transmission element, which is mounted on a screwed-in mounting pin 33 on the lever arm 25 of the cutting lever 20. The connecting link guide 30 has a width B, which corresponds to the diameter d of the roller 31 (FIG. 12).

The roller 31 is thus restrictedly guided in the connecting link guide 30 provided with rounded-off ends in both pivoting directions of the lever arm 11.

As is shown in FIGS. 13 and 14, a sliding block 31′ may be used as a transmission element instead of a roller 31, in which case the sliding surfaces 32 and 33 of the sliding block have curvatures which are adapted to the curvatures of the curved paths K and K′ of the connecting link guide 30′, which is somewhat longer in this case and is provided with radially extending end faces 34 and 35. As is apparent from FIG. 14, the sliding block has the shape of a circular ring section with radial end faces 36 and 37 and a bearing hole 38.

The curved path K extending over an angle δ is decisive for the transmission of power and movement from the short plate-like lever arm 11 of the second hand lever 10 to the cutting lever 20, whose second lever arm 26 is provided with the second cutting tips 27. This curved path K is arranged at a certain distance from the joint of pliers Z and has such a shape that the radial distance a between the lines of force KL₀, KL₁ and KL₂ of the cutting force component acting on the curved path K at the power transmission point and the axis S of the joint of pliers Z during the closing movement of the second hand lever 10 changes from a maximum (a₀) at the beginning of the closing movement to a minimum (a₂) at the end of the closing movement.

These changing distances a₀, a₁ and a₂ are identical to the respective effective lever arm at which the power is transmitted from the short lever arm 11 of the hand lever 10 to the cutting lever 20. This described change in the effective lever arm from a₀ to a₂ takes place during the closing movement as a consequence of the curvature of the curved path K. It is also important in this connection that the starting point A, which is in contact with the roller 31 at the beginning of the closing movement, has a shorter distance from the axis S of the joint of pliers Z than the end point E with the distance s₂.

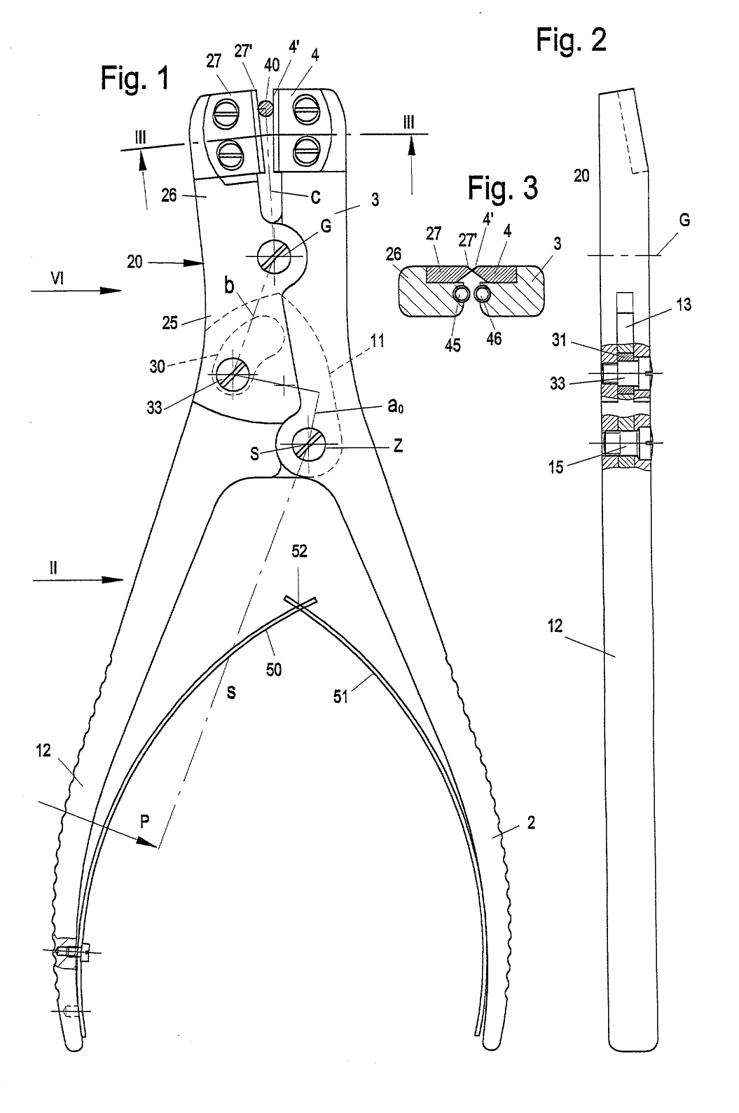

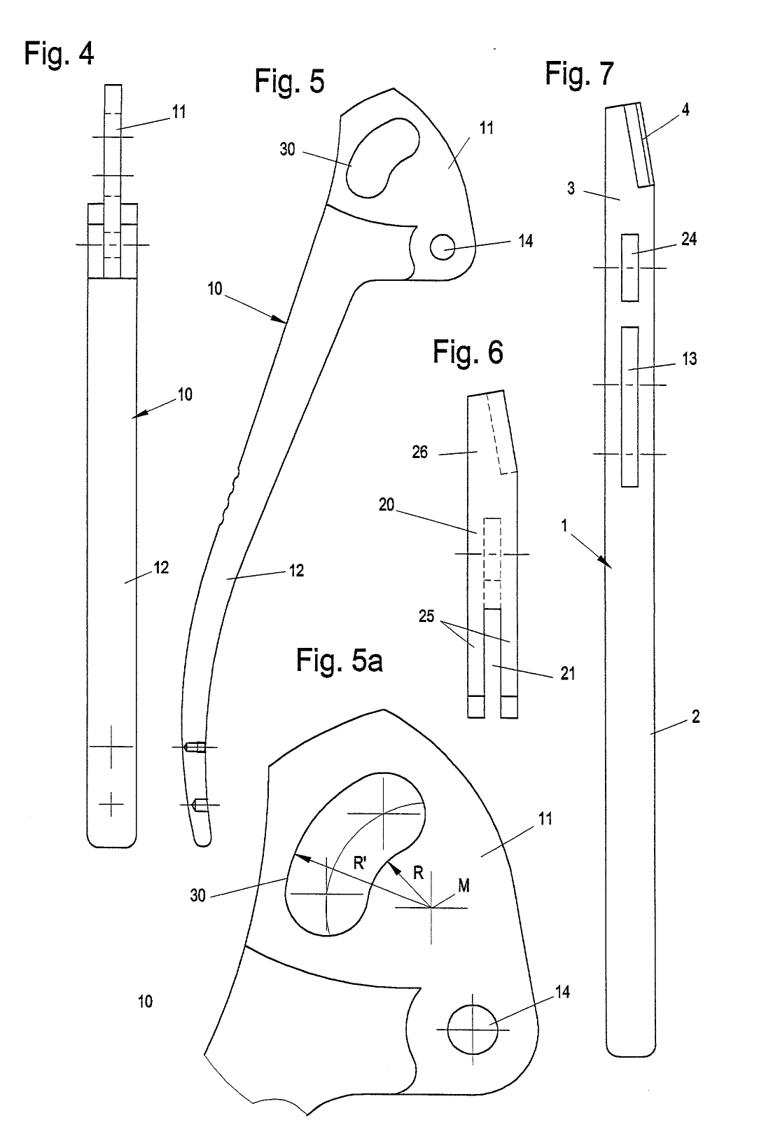

In the exemplary embodiment shown in FIGS. 1 through 16, the distance s₂ is about 10% to 15% greater than the distance s₁. Due to the concave shape of the curved path K, all the distances of the curved path K located between A and E are greater than s₀.

In this embodiment, the curved path K has a constant curvature, whose center of curvature M is located on the side of the straight line ES connecting the end E of the curved path K to the axis S of the joint of pliers Z, which side faces away from the lever arm 12. The radius of curvature R of the curved path K is smaller by at least one third than the length of this straight line ES or the distance s₂.

In the preferred embodiment, the radius of curvature R of the curved path K approximately corresponds to half the length of the straight line ES or to half the distance s₂ between the end point E of the curved path K and the axis S of the joint of pliers Z.

As is apparent from FIG. 16, the center of the curvature M has a distance q from the straight line ES; it would be possible, in principle, to select this distance q as desired, but it is decisive for the size of the effective lever arm a₀ at the beginning of the closing and cutting movement as well as for the smallest possible lever arm a₂ at the end of the closing movement.

If this center of curvature M is placed directly on the straight line ES, the lever arm a₂ acting at the end of the closing movement becomes zero. The cutting force would theoretically become infinite as a result. However, there is practically no more transmission of movement in such a case, which means that the center of curvature M must always be located at a minimum distance from the straight line ES. In a preferred embodiment, this distance q approximately corresponds to one twelfth of the radius of curvature R of the curved path K. In any case, this distance q should be smaller than one tenth of the radius of curvature R to ensure that a transmission of movement or power transmission could or can still take place even at the end of the closing movement.

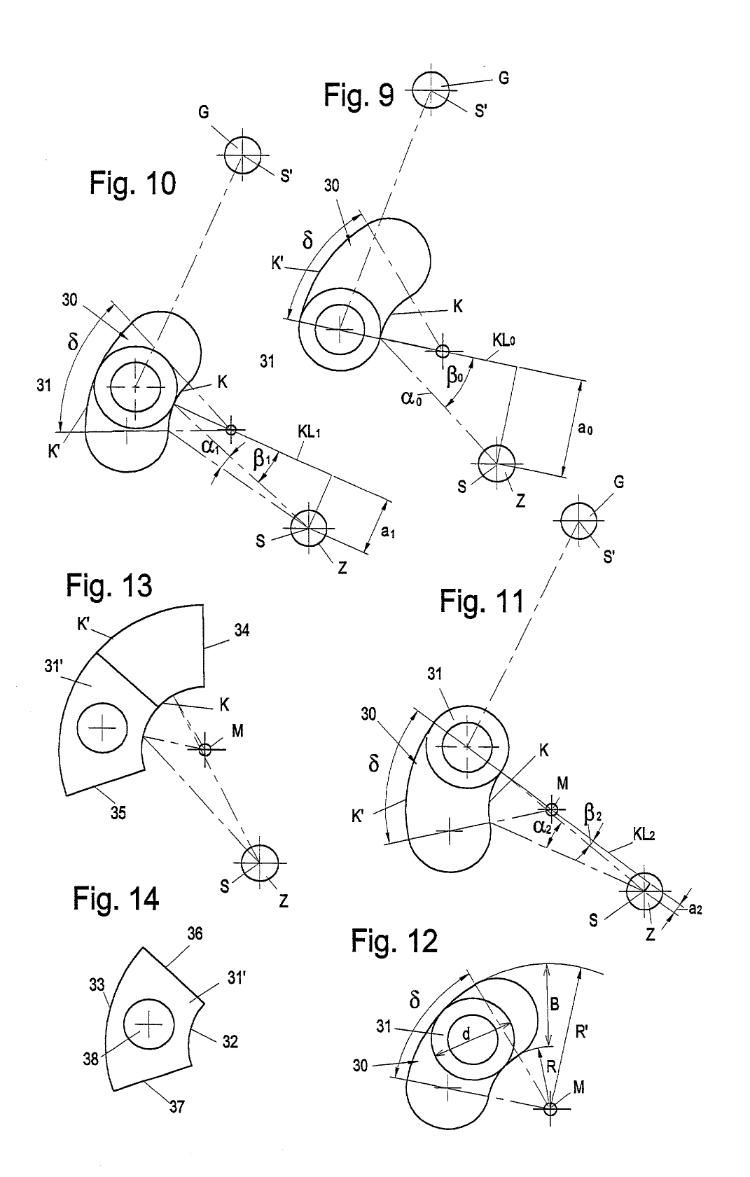

How the lever arms a₀, a₁ and a₂ acting between the curved path K and the roller 31 on the short lever arm 11 of the second hand lever 10 during the closing movement over the angle α₂ change is shown in FIGS. 9, 10 and 11 as well as 15 for three movement angles α₀, α₁, α₂. The respective angles β₀, β₁, β₂, which form the respective lines of force KL₀ and KL₁ and KL₂ at the contact points A, E₁ and E with the lines or straight lines AS, E₁S and ES which connect these contact points A, E₁ and E to the axis S of the joint of pliers Z, correspond to these movement angles α₀, α₁, α₂ of the second hand lever 10 and consequently also to the curved path K of the short lever arm 11.

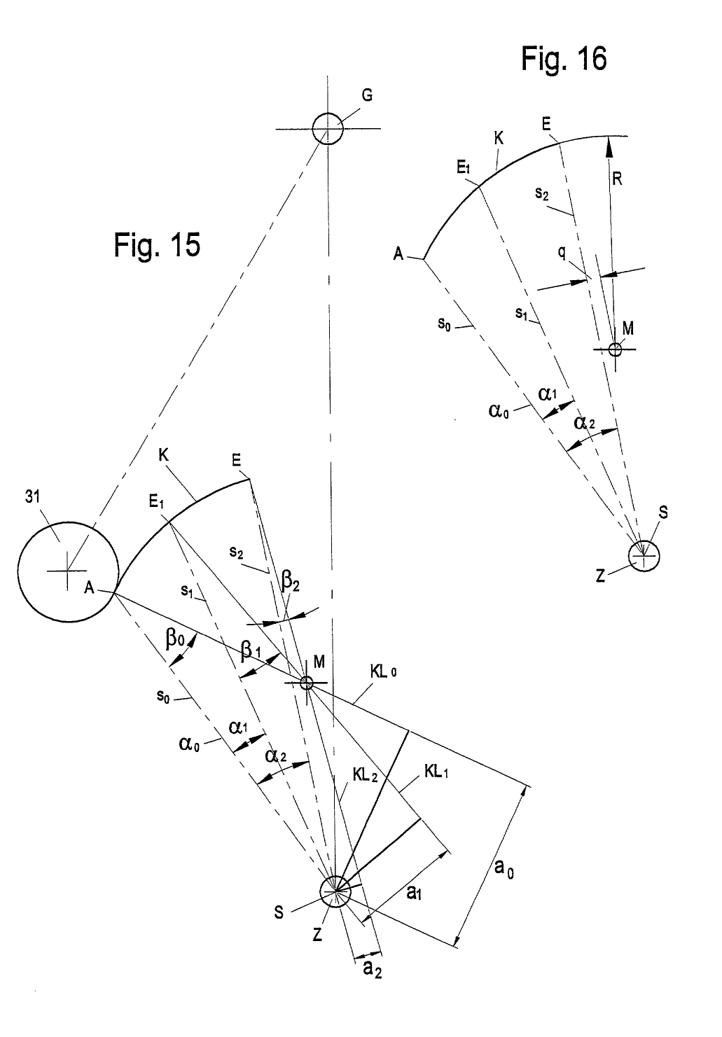

It is also recognized from FIGS. 15 and 16 that the lengths of these straight connecting lines AS and E₁S and ES also change in terms of a continuous increase, which ultimately leads to the deflecting movement or cutting movement of the cutting lever 20, which is exerted on same by the curved path K via the roller 30.

As can be recognized from FIGS. 9 through 12, the curved path K forms the connecting link guide 30 with a second curved path K′ which is parallel to it, and the connecting link guide 30 is advantageously provided with rounded ends in case of the use of a roller 31 as the transmission element.

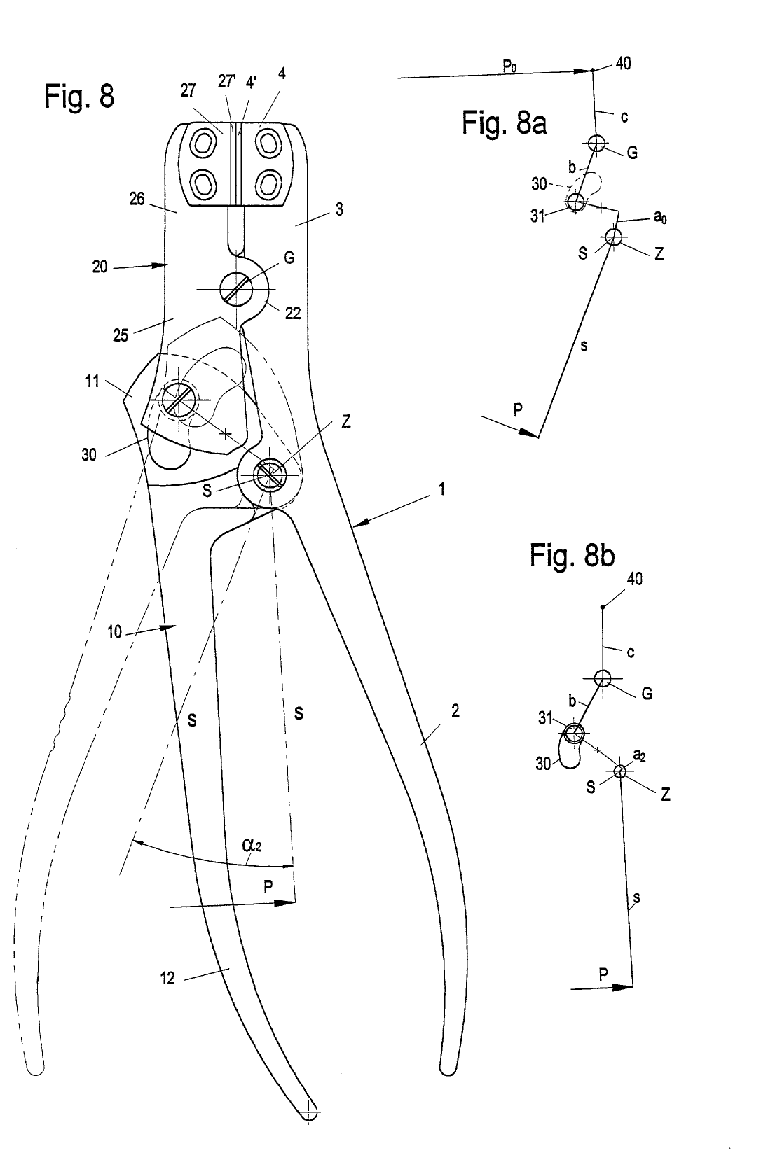

At the lever ratios corresponding to a practical embodiment of the cutting pliers according to the present invention, which are schematically shown in FIGS. 8a and 8b, the cutting forces P₀, P₁ and P₂, which occur at the movement angles α₀, α₁ and α₂ shown in FIG. 15 during the cutting off of a wire 40 (FIG. 1), can be calculated as follows:

$$\begin{matrix}{P}_{0} = \frac{s}{{a}_{0}} * \frac{c}{b} \\ {P}_{0} = \frac{s}{{a}_{0}} * \frac{c}{b} \\ {P}_{2} = \frac{s}{{a}_{2}} * \frac{c}{b}\end{matrix}$$

Here, s is the lever arm on which the manual force P of the user acts; a₀, a₁, a₂ are the respective lever arms which change with increasing closing movement and act between the short lever arm 11 and the cutting lever 20; b is the lever arm between the joint G and the roller 31, and c is the lever arm between the joint G and the wire 40 to be cut off.

If a manual force P=100 N, s=100 mm, a₀=10.5 mm, a₁=7 mm, a₂=1.66 mm, b=30 mm and c=35 mm are assumed, the following values will be obtained from the above formulas for the cutting forces acting on the wire 40:

P₀=816.8 N, P₁=1,224.5 N,

and

P₂=5,163.5 N.

It can be recognized from this that the cutting force is 6.33 times greater at the end of the closing movement than at the beginning of the closing movement, i.e., P₂=6.33×P₀. In addition, it is recognized that the progression is substantially smaller during the first half of the closing movement, i.e., in the angle range α₁, than during the remaining half of the closing angle α₂.

It can also be recognized from the views in FIGS. 9 through 11 and 15 that the lever arms a₀, a₁, a₂ acting on the roller 31 via the curved path K can be calculated according to the formula a₀=s₀ x sin β₀, a₁=s₁ x sin β₁ and a₂=s₂ x sin β₂, where s₀, s₁ and s₂ are the respective distances between the axis S of the joint of pliers Z and the corresponding contact point A or E1 and E of the roller 31 with the curved path K.

The respective angle values β₀, β₁ and β₂ can be calculated from the corresponding relationships between α₀, α₁ and α₂, on the one hand, and the angle δ, on the other hand.

δ is the angle of the circle segment enclosed by the curved path K and the center of curvature M as the center.

As was mentioned in the introduction, it is also possible with this design principle to provide a curved path with different pitches or curvatures in order to obtain different progressions of the cutting force P₀ and P₂ available on the cutting edges 4′ and 27′.

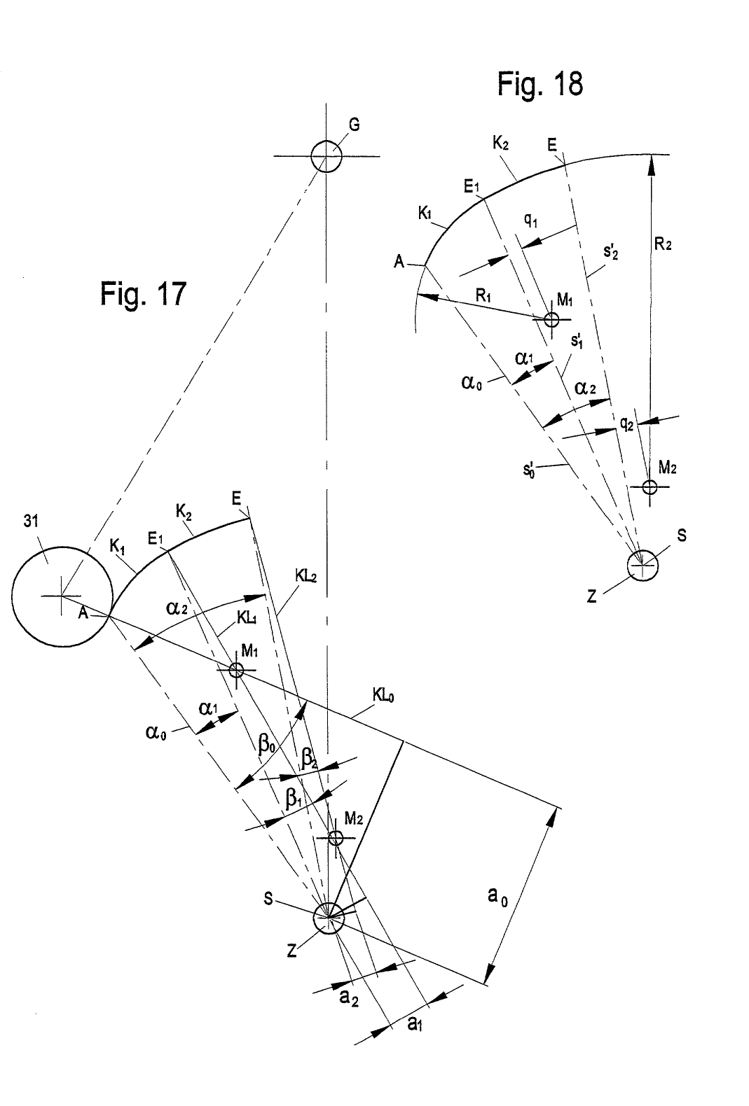

Such an exemplary embodiment is schematically shown in FIGS. 17 and 18. The curved path beginning at the starting point A and ending at the end point E comprises two segments K₁ and K₂, which have different radii of curvature R₁ and R₂ and also different centers of curvature M₁ and M₂.

The center of curvature M₁ of the curved path K₁ is located on the side of the straight connecting line s₂′ or E₁S connecting the end point E₁ of the first curved section K₁ to the axis S of the joint of pliers Z, which side is located opposite the lever arm 12 of the hand lever 10. The center of curvature M₁ has a distance q₁ from this straight line S₁′ or AS, this distance being at least approximately equal to the distance q between the center M in the above-described exemplary embodiment and the straight connecting line ES=s₂.

This curved section K₁ has a radius of curvature R₁ that corresponds to about one third of the length of the straight line S₂′. The curved section K₂ joining the section K₁ without a step has a radius of curvature R₂ that is about twice the radius of curvature R₁. The center of curvature M₂ of this curved section K₂ is located on the side of the straight connecting line S₂′ connecting the end point E of the curved section K₂ to the axis S of the joint of pliers Z, which side is located opposite the lever arm 12 of the hand lever 10.

It is recognized here as well that the distance or the length of the straight line S₀′=AS, which connects the starting point A of the curved section K₁ to the axis S, is smaller than the length of the straight line S₁′=E₁S, and this is in turn smaller than the length of the straight line S₂′=ES. As can be recognized from FIG. 17, different cutting force progressions can be obtained on the cutting edges 4′, 27′ with such an arrangement. While a substantially greater progression of the cutting force P₀ and P₂ takes place during the movement in the range of the closing angle α₁ in the range of the curved sections K₁ with the substantially smaller radius of curvature R₁, this progression is also substantially smaller in the range of the curved section K₂ with the substantially greater radius of curvature R₂.

While the lever arm a₁ decreases by about four fifths to one fifth at the end of the angular movement α₁, the reduction from a₁ to a₂ during the remaining half of the closing movement α₂ or cutting movement is only about one third. This means that the increase in the force on the cutting edges 4′, 27′ increases fivefold during the first half of the cutting movement and only threefold during the last half of the cutting movement.

It is recognized from this that greatly variable progressions of the changes in the force, which are adapted to the particular needs, can be selected in the case of this design and function principle, without the cutting pliers requiring a greater manufacturing effort as a result. It might also be highly advantageous that the curved paths needed in the particular case can be easily determined by calculation as well as graphically.

To hold the cut-off parts of a wire 40, a screw or the like at the time of the cutting off for at least a limited time, elastic wire holders 45, 46 are arranged opposite each other on the two cutting arms 3 and 26 having a cutting tip 4 and 27 each in the immediate vicinity of the two cutting edges 4′ and 27′.

To hold the two hand levers 1 and 10 in the spread-out position shown in FIG. 1 and to return them into this position after each cutting operation, leaf springs 50 and 51, which are connected to one another at their ends by a joint 52, are arranged on the inner sides of the hand levers. The other ends of these two leaf springs 50 and 51 are fastened to the inner sides of the lever arms 2 and 12 by screws.

While specific embodiments of the invention have been shown and described in detail to illustrate the application of the principles of the invention, it will be understood that the invention may be embodied otherwise without departing from such principles.

What is claimed is:

1. Cutting pliers, comprising:
a first two-armed hand lever with a handle rear lever arm and a front lever arm with a cutting edge provided on a front end section of said front lever arm front end section, said front lever arm being shorter than said rear lever arm;
a second two-armed hand lever pivotably articulated to the first hand lever by a pliers joint, said second hand lever having a handle rear lever arm arranged approximately mirror symmetrically to said first hand lever handle rear lever arm and having second hand lever front lever arm, said second hand lever front lever arm being shorter than said second hand lever rear lever arm;
a two-armed cutting lever having a second cutting edge, said second hand lever front lever arm having a transmission connection via a lever transmission to a rear lever arm of said two-armed cutting lever, said two-armed cutting lever being articulated to said first hand lever front lever arm such that a cutting force exerted on the cutting edges by means of the handles increases super proportionally with increasing closing movement, said second hand lever front lever arm having, at a radial distance from said pliers joint, a curved path via which said second hand lever front lever arm acts on said rear lever arm of said two-armed cutting lever, said cutting lever having a transmission element rolling or sliding along said curved path with low friction, said curved path extending such that a radial distance between lines of force of a cutting force component acting at the power transmission point on the curved path during a closing movement of the second hand lever and the axis of the pliers joint changes from a maximum at the beginning of the closing movement to a said minimum at the end of the closing movement.

2. Cutting pliers in accordance with claim 1, wherein the curved path has a continuous shape within a movement angle of the second hand lever and a radial distance between a beginning of said curved path, which is located closer to the pliers joint, and said axis of the pliers joint, is shorter than a radial distance between an end of said curved path and said axis of the pliers joint.

3. Cutting pliers in accordance with claim 1, wherein said curved path has an at least approximately constant curvature with a center of curvature located on a side of a straight line connecting an end of said curved path to said axis of pliers joint, which side faces away from said rear lever arm of said second hand lever, and which has a radius of curvature smaller by at least one third than a length of said straight line.

4. Cutting pliers in accordance with claim 3, wherein a radius of curvature of said curved path corresponds at least approximately to half of a distance between an end of said curved path and said axis of pliers joint and a center of curvature of said curved path is located at a distance from a straight line which is smaller than one tenth of a radius of curvature of the curved path.

5. Cutting pliers in accordance with claim 1, wherein said curved path forms a connecting link guide for said transmission element of said cutting lever with a second curved path parallel to said curved path, said connecting link guide having a shape of a curved elongated hole.

6. Cutting pliers in accordance with claim 5, wherein said transmission element comprises a roller mounted rotatably on said cutting lever, said roller having a diameter adapted to a width of said connecting link guide.

7. Cutting pliers in accordance with claim 3, wherein said transmission element comprises a sliding block mounted in an articulated manner on said cutting lever and having a sliding surfaces with curvatures which are adapted to curvatures of the curved paths of the connecting link guide.

8. Cutting pliers in accordance with claim 1, wherein within a movement angle of said second hand lever said curved path has at least two curved path sections with different radii of curvature, and a beginning of a first curved path section located closer to said pliers joint has a smaller radius of curvature and has a smaller radial distance from said axis of the pliers joint than at an end of said first curved path section and an end of a second curved path section has a greater radial distance from said axis of the pliers joint than a beginning of said second curved path section which coincides with said first curved path section.

9. Cutting pliers in accordance with claim 8, wherein a center of curvature of the first curved path section is located on a side of a straight line facing away from said second hand lever, which said straight line connects said axis of the pliers joint to an end of said first curved path section, and a corresponding radius of curvature is smaller than half of a radial distance between an end of said first curved path section and an axis of the pliers joint.

10. Cutting pliers in accordance with claim 8, wherein a center of curvature of said second curved path section is located on a side of a straight line facing away from said second hand lever, which said straight line connects said axis of the pliers joint to an end of said second curved section, and a corresponding radius of curvature is greater than half of a radial distance between an end of said second curved path section and said axis of the pliers joint.

11. Cutting pliers in accordance with claim 1, further comprising elastic wire holders connected respectively to said first two-armed hand lever front lever arm and to a front lever arm of said two-armed cutting lever, said elastic wire holders being arranged opposite one another and adjacent to said cutting edge and said second cutting edge.

12. Cutting pliers in accordance with claim 2, wherein said curved path has an at least approximately constant curvature with a center of curvature located on a side of a straight line connecting an end of said curved path to said axis of pliers joint, which side faces away from said rear lever arm of said second hand lever, and which has a radius of curvature smaller by at least one third than a length of said straight line.

13. Cutting pliers in accordance with claim 9, wherein a center of curvature of said second curved path section is located on a side of a straight line facing away from said second hand lever, which said straight line connects said axis of the pliers joint to an end of said second curved section, and a corresponding radius of curvature is greater than half of a radial distance between an end of said second curved path section and said axis of the pliers joint.

14. Surgical cutting pliers for cutting through elements including for cutting through said wires, nails, screws, the surgical cutting pliers comprising:
a first two-armed hand lever with a handle rear lever arm and a front lever arm with a cutting edge provided on a front end section of said front lever arm, said front lever arm being shorter than said rear lever arm;
a second two-armed hand lever pivotably articulated to the first hand lever by a pliers joint, said second hand lever having a handle rear lever arm arranged substantially opposite to said first hand lever handle rear lever arm and having second hand lever front lever arm, said second hand lever front lever arm being shorter than said second hand lever rear lever arm;
a two-armed cutting lever having a second cutting edge, said second hand lever front lever arm having a transmission connection via a lever transmission to a rear lever arm of said two-armed cutting lever, said two-armed cutting lever being articulated to said first hand lever front lever arm such that a cutting force exerted on the cutting edges by means of the handles change super proportionally with increasing closing movement, said second hand lever front lever arm having, at a radial distance from said pliers joint, a curved path via which said second hand lever front lever arm acts on said rear lever arm of said two-armed cutting lever, said cutting lever having a transmission element rolling or sliding along said curved path with low friction, said curved path extending such that a radial distance between lines of force of a cutting force component acting at the power transmission point on the curved path during a closing movement of the second hand lever and the axis of the pliers joint changes from a maximum at the beginning of the closing movement to a said minimum at the end of the closing movement.
